(19) United States
(12) Patent Application Publication
(10) Pub. No.: US 2013/0214059 A1
(43) Pub. Date: Aug. 22, 2013

(54) WATER SPRAYING SYSTEM

(71) Applicants: Richard J. Gilpatrick, Whitewater, WI (US); Jason J. Raasch, Cedarburg, WI (US)

(72) Inventors: Richard J. Gilpatrick, Whitewater, WI (US); Jason J. Raasch, Cedarburg, WI (US)

(73) Assignee: Briggs & Stratton Corporation

(21) Appl. No.: 13/399,931

(22) Filed: Feb. 17, 2012

(51) Int. Cl. B05B 15/00

(52) U.S. Cl. 239/289

(57) ABSTRACT

A water spraying system is configured for a variety of outdoor cleaning applications. In one embodiment, the water spraying system includes a water pump assembly having a water pump, a receiver configured to receive wireless communications, and an actuator coupled to the receiver and configured to change at least one of water pressure and flow rate provided by the water pump. A spray gun is configured to spray water provided by the water pump and includes an electronic display, circuitry configured to provide a graphical user interface via the electronic display, and a transmitter configured to wirelessly provide instructions to the actuator by way of the receiver based on input provided by the operator such that the operator may change at least one of the water pressure and the flow rate provided by the water pump via the graphical user interface of the spray gun.

### BACKGROUND

The present invention relates generally to a device that pressurizes and sprays water, such as for outdoor cleaning applications. More specifically, the present invention relates to a device that is configured to condition the flow of water, such as by changing the flow rate, the water pressure, the shape of the flow exiting the device, or other characteristics of the flow, in order to customize performance of the device to one of a variety of outdoor cleaning tasks.

Different water spraying devices are used for different applications. Garden hose sprayers may be attached to garden hoses and typically include nozzles that constrict the flow path of water in order to condition the flow for various applications, such as cleaning windows, washing a car, watering plants, etc. Flow rate and water pressure are limited by the water source supplying water to the garden hose sprayer, which may be insufficient for some applications.

Pressure washers typically include pumps to increase the pressure of water for heavy-duty cleaning and resurfacing applications. The water pressure is greatly increased relative to typical garden hose sprayer, but the flow rate may be decreased and the intensity of the spray may be too great from some applications, such as cleaning windows and watering plants.

Garden hose booster systems may increase the flow rate was well as water pressure relative to the household water supply, such as for cleaning and other general outdoor tasks. However the water pressure increase by the garden hose booster is typically less than that of a pressure washer. A need exists for a water spraying device configured for a wide variety of outdoor cleaning applications.

### SUMMARY

One embodiment of the invention relates to a water spraying system configured for a variety of different outdoor cleaning applications. The water spraying system has a water pump configured to operate in only two modes, a first mode corresponding to a first range of water pressure and a range of water flow rate, and a second mode corresponding to a second range of water pressure and a second range of water flow rate. The first range of water pressure does not overlap the second range of water pressure, and the first range of water flow rate does not overlap the second range of water flow rate. The water spraying system further includes a spray gun coupled to the water pump having an interface configured to allow an operator to change the mode of operation of the water pump.

Another embodiment of the invention relates to a water spraying system configured for a variety of outdoor cleaning applications. The water spraying system includes a water pump assembly having a water pump, a receiver configured to receive wireless communications, and an actuator coupled to the receiver and configured to change at least one of water pressure and flow rate provided by the water pump. The water spraying system further includes a spray gun configured to spray water provided by the water pump, the spray gun having an electronic display, circuitry configured to provide a graphical user interface via the electronic display, and a transmitter configured to wirelessly provide instructions to the actuator by way of the receiver based on input provided by the operator, such that the operator may change at least one of the water pressure and the flow rate provided by the water pump via the graphical user interface of the spray gun.

Yet another embodiment of the invention relates to a water spraying system having a water pump with a piston for pumping water and a cam that rotates and includes a face contacting the piston, where the face is oriented at a slant angle relative to a plane orthogonal to the axis of rotation of the cam such that rotation of the cam drives the piston. An actuator is configured to change the slant angle of the cam where the actuator is configured to move the cam between first and second slant angles such that the cam drives the piston to a lesser stroke length when the cam is oriented at the first slant angle compared to when the cam is oriented at the second slant angle. A spray gun is in communication with the actuator and includes an interface configured to allow an operator to change the slant angle of the cam via the actuator.

Yet another embodiment of the invention relates to a water spraying system including an prime mover having a variable prime mover speed and a water pump driven by the prime mover at a pump speed that is related to the prime mover speed. A hose is coupled to an outlet of the water pump and a nozzle is coupled to the hose and configured to spray water delivered by the pump. The nozzle has a first setting having a first output cross-section and a second setting having a second output cross-section, where the second output cross-section is less than the first output cross section. The prime mover speed and the pump speed are higher when the nozzle is in the first setting than when the nozzle is in the second setting.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is perspective view of a water spraying device. according to an exemplary embodiment.

FIG. 2 is a sectional view of a water pump. according to an exemplary embodiment.

FIGS. 3-4 are schematic diagrams associating a slant angle of a cam of water pump with characteristics of a resulting water flow. according to an exemplary embodiment.

FIG. 5 is an isometric sectional view of a portion of the water pump of FIG. 2.

FIG. 6 is a side view of the nozzle end of a spray gun for a water spraying device. according to an exemplary embodiment.

FIG. 7 is a sectional view of the nozzle end of FIG. 6.

FIG. 8 is a sectional view of the nozzle end of a spray gun for a water spraying device. according to an exemplary embodiment.

FIG. 9 is a sectional view of the nozzle end of FIG. 8, taken along line 9-9.

FIG. 10 is a schematic diagram of water pressure and flow rate of three different modes of a water pump. according to an exemplary embodiment.

FIG. 11 is a perspective view of components of a water spraying device. according to an exemplary embodiment.

FIG. 12 is a schematic diagram of water pressure and flow rate of three different modes of a water pump. according to an exemplary embodiment.

FIG. 13 is a perspective view of a spray gun. according to an exemplary embodiment.

FIG. 14 is a flow chart including steps for changing a mode of operation of a water spraying device. according to an exemplary embodiment.

FIG. 15 is a flow chart including steps for changing another mode of operation of a water spraying device. according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

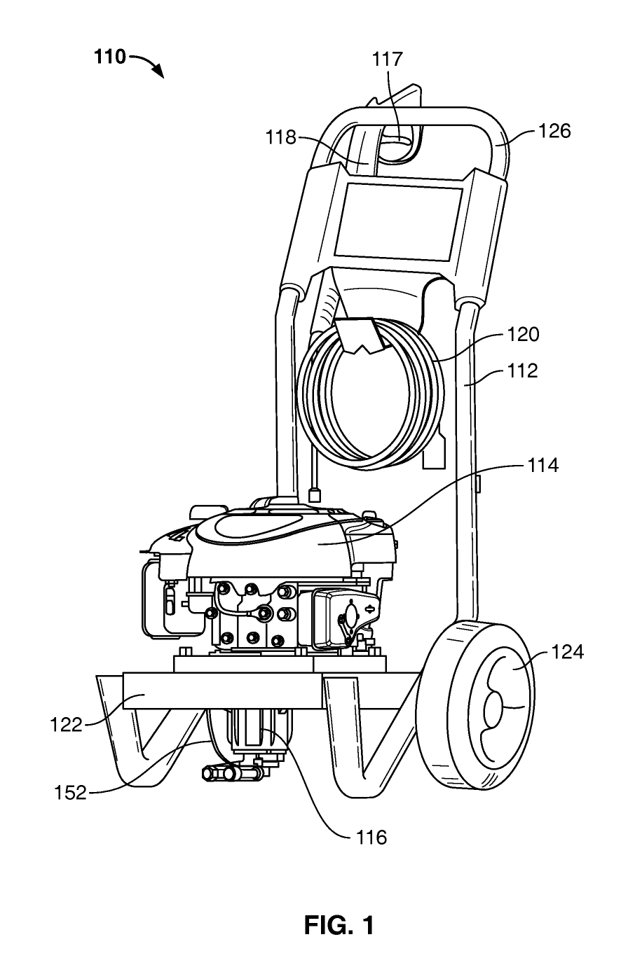

Referring to FIG. 1, a water spraying device 110 includes a frame 112 supporting a prime mover such as an engine 114 and a water pump 116 (e.g., positive displacement pump, piston water pump, axial cam pump) configured to be connected to a spray gun 118 with a hose 120. According to an exemplary embodiment, the engine speed is controlled by a stepped motor coupled to the engine governor. In some embodiments, the engine 114 is fastened to the top of a base plate 122 of the frame 112 and the water pump 116 is mounted below the base plate 122 and connected to a power takeoff of the engine 114 via a hole through the base plate 122 (not shown). In some embodiments, the water spraying device 110 is portable and includes wheels 124 and a handle 126. In other embodiments, an electric motor is used in place of the engine and the water spraying device may be stationary. According to one exemplary embodiment, the water pump may be powered by an electric motor with a power output of between 0.25 and 10 horsepower. In some embodiments, the electric motor may be an AC motor operated from an electrical power source between 120VAC and 440VAC at between 50 Hz and 60 Hz. In other embodiments, the electric motor may be an DC motor operated from an electrical power source between 12 V and 48 V. The motor speed is controlled by a speed controller (e.g., a speed control circuit).

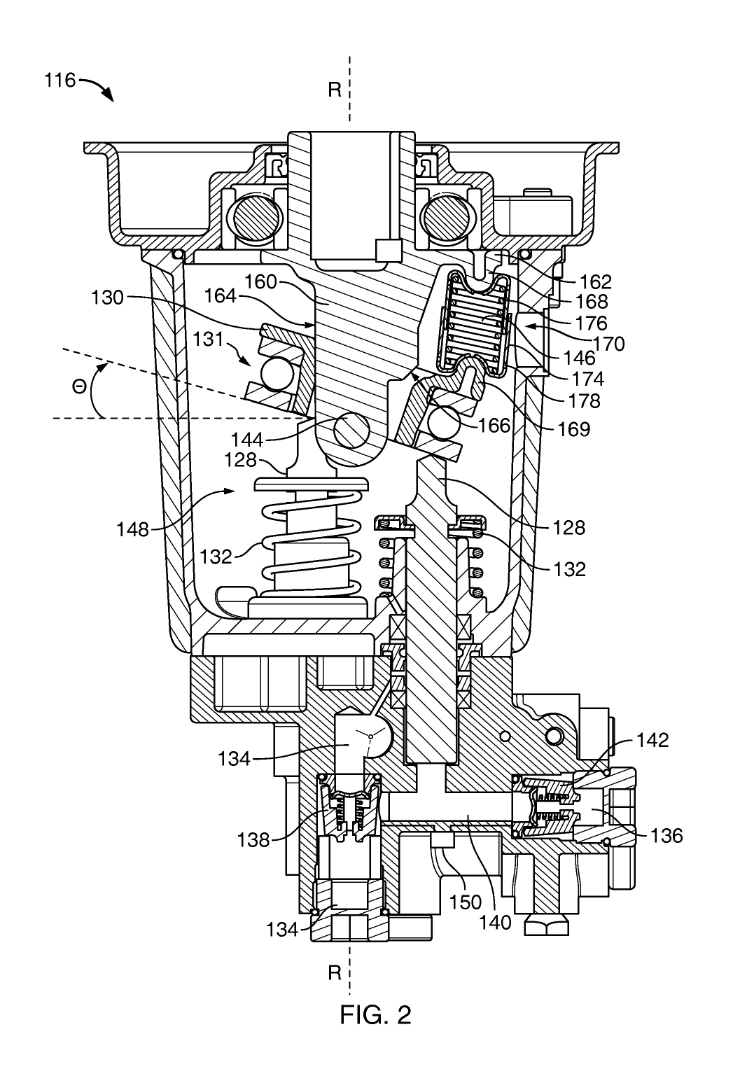

Referring to FIG. 2, the water pump 116 is shown as having an interior chamber 148 containing pistons 128 and a cam 130 (e.g., wobble plate, swashplate, etc.) configured to be connected with the power takeoff of the engine 114. Because the cam 130 is connected to the power takeoff of the engine 114, the pump speed (e.g., cam RPM) is a function of the engine speed. According to an exemplary embodiment, the water pump 116 includes three pistons 128 arranged symmetrically about the axis of rotation R of the cam 130. A face of the cam 130 is angled and contacts the piston 128. The cam 130 may include a bearing device 131 to reduce friction losses between the cam 130 and the pistons 128. The piston 128 is biased to a first position with a spring 132, and as the cam 130 rotates, the slanted face of the cam 130 overcomes the bias and drives the piston (e.g., piston 128) to pump water. Movement of the piston 128 draws water from an inlet 134 through a first check valve 138 and into a pumping chamber 140, then pushes the water through a second check valve 142 to an outlet 136 (e.g., manifold) of the water pump 116. The flow rate of the pump 116 is related to (e.g., proportional to) the rate of rotation of the cam 130 and the stroke length of the piston 128. The stroke length of the piston 128 (e.g., from top dead center to bottom dead center) is related to the slant angle θ of the face of the cam 130. According to an exemplary embodiment, the cam 130 pivots relative to a base or holder 160 about a central joint 144. The central joint 144 allows the cam 130 to rotate about an axis orthogonal to the axis of rotation R of the cam 130 (and the power takeoff).

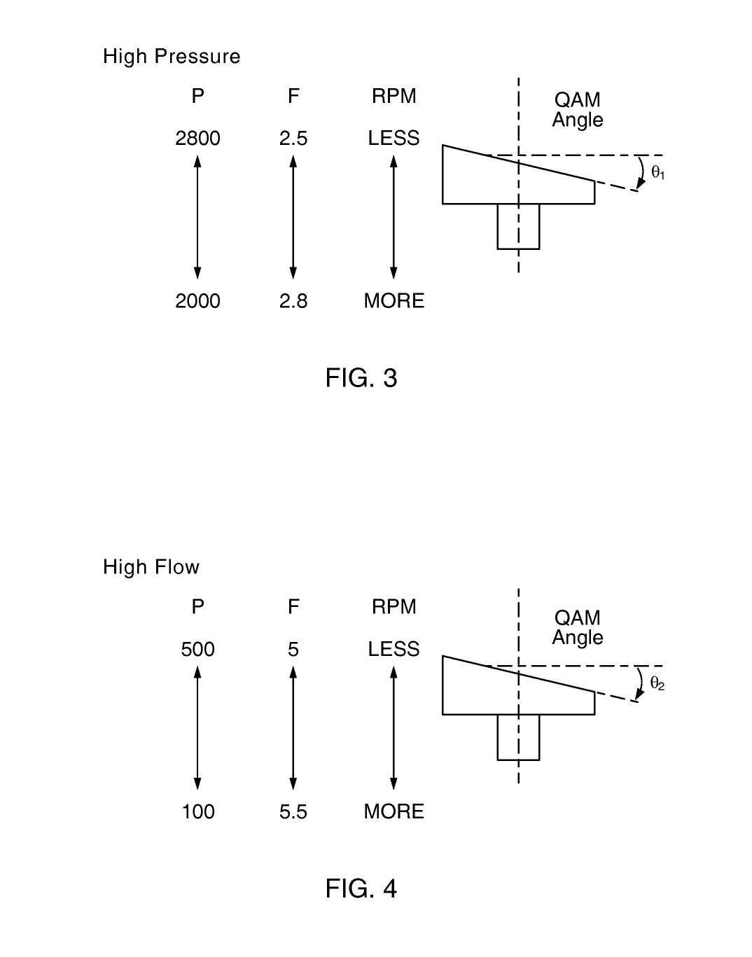

Referring to FIGS. 3-4, hypothetical flow characteristics are provided as a function of slant angle θ of the cam 130. At a first slant angle θ₁, the engine-powered water pump provides output at a pressure of 2000 to 2800 pounds per square inch (psi) and a flow rate of 2.5 to 2.8 gallons per minute (gpm), where variation within the ranges may be at least partially controlled by engine speed (i.e., revolutions per minute). At a second slant angle θ₂, the water pump provides output at a pressure of 100 to 500 psi and a flow rate of 5 to 5.5 gpm. Accordingly, the first slant angle θ₁ may be better suited for higher pressure applications, while the second slant angle θ₂ may be better suited for higher flow rate applications.

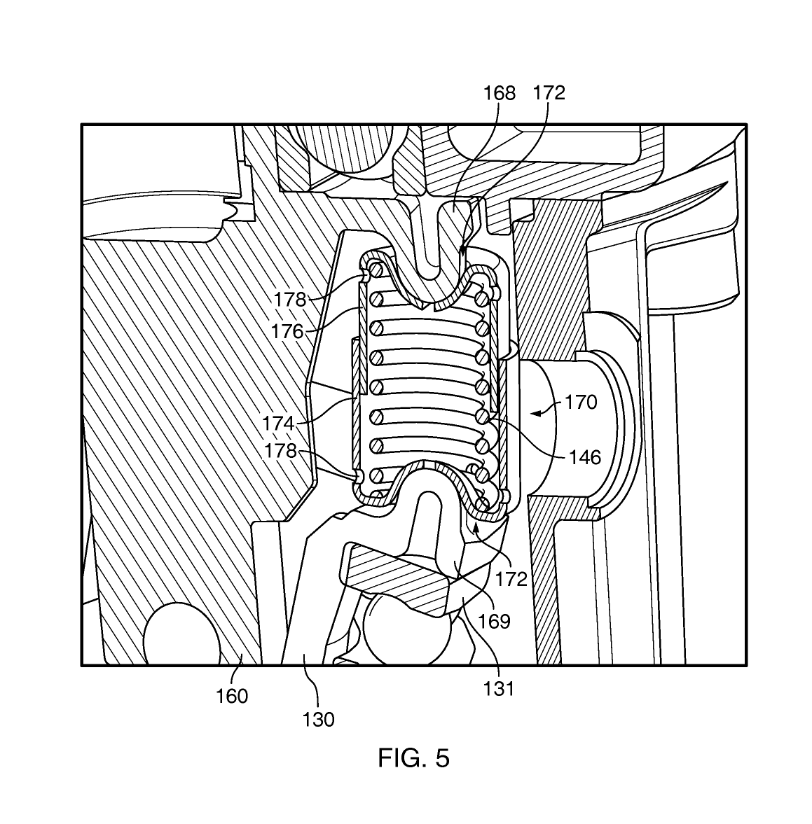

Referring to FIGS. 2 and 5, the cam 130 is biased towards the steeper, first slant angle by a spring 146 that is compressed between the cam 130 and an upper flange 162 of the holder 160. The spring 146 is contained within a telescoping enclosure 170 (e.g., holder, container, cup, casing, etc.). The enclosure 170 prevents the spring 146 from deforming due to centripetal forces as the cam 130 rotates. The cam 130 is prevented from exceeding the first slant angle by a first contact surface 164 of the holder 160. The cam 130 is prevented from exceeding the second slant angle (and flattening out, resulting in zero displacement of the pistons 128) by a second contact surface 166 of the holder 160.

The enclosure 170 is rotatably and pivotally coupled to the holder 160 and to the cam 130 via projections 168 and 169, respectively. The projections 168 and 169 are received in hollows 172 on either end of the enclosure 170. The enclosure 170 includes a first cup-shaped portion 174 and a second cup-shaped portion 176. The first portion 174 has a diameter that is larger than the diameter of the second portion 176, allowing the second portion 176 to nest within the first portion 174. The first portion 174 may therefore slide relative to the second portion 176, providing the enclosure 170 with a variable interior volume that can adjust with the length of the spring 146 as the cam 130 moves from the first slant angle to the second slant angle. The interior of the enclosure 170 may be filled with oil. As the interior volume of the enclosure 170 increases or decreases in response to the extension or compression of the spring 146, oil can be drawn into or expelled from the interior of the enclosure 170 through openings 178 in the first portion 174 or the second portion 176. A thin layer of oil between the overlapping walls of the first portion 174 and the 176 creates a fluid bearing. Further, the flow of the oil in and out of the enclosure 170 may be effective to dampen the oscillations of the spring 146.

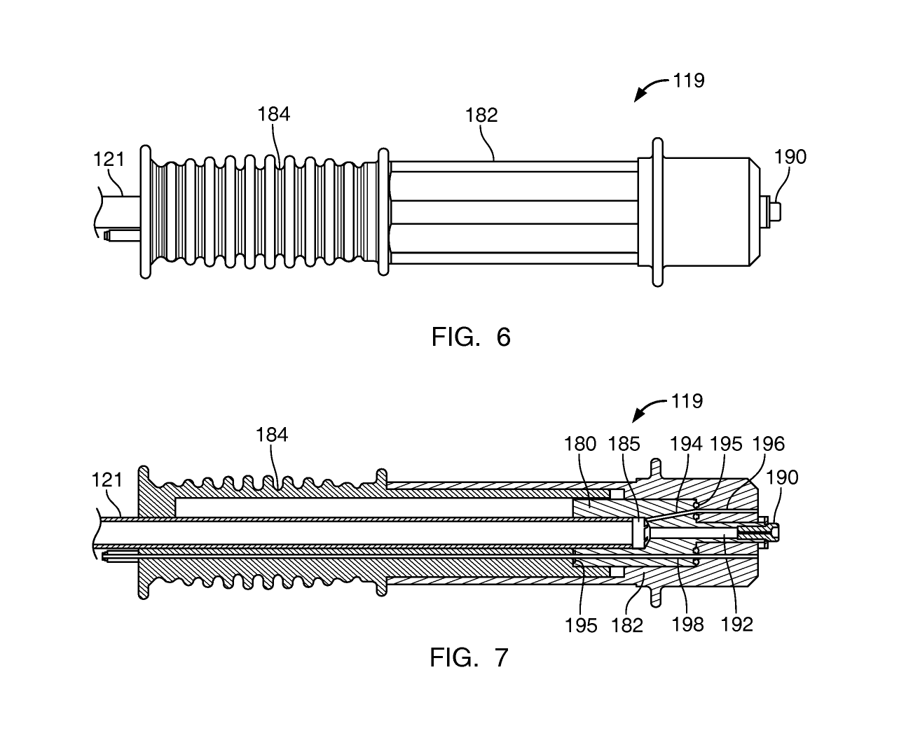

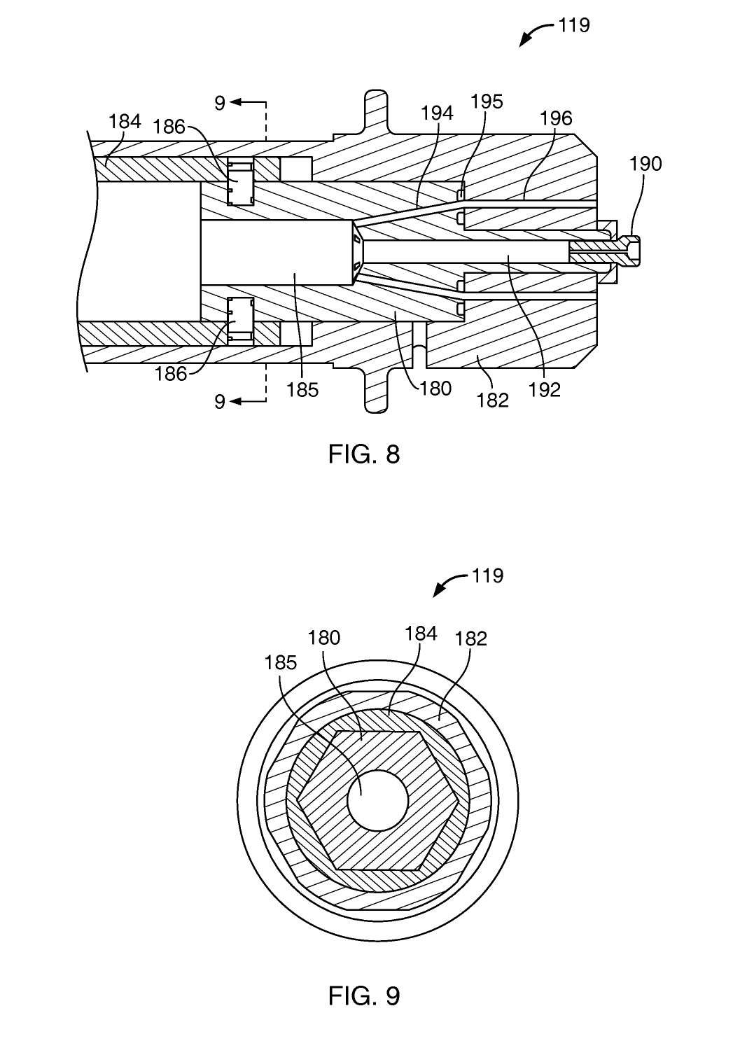

Referring to FIGS. 6-9, the nozzle end 119 of the spray gun 118 is shown according to an exemplary embodiment. The nozzle end 119 is coupled to the end of a conduit 121. As shown, the nozzle end 119 may be a relatively simple mechanism including an inner body or base 180 coupled to the end of the hose 120, an outer body or shell 182, and a grip 184. The grip 184 is a tube-like member that is rotationally locked to the base 180. As shown in FIG. 9, the inner surface of the grip 184 and the outer surface of the base 180 may each be polygonal (e.g., hexagonal). Further, coupling members such as spring pins 186 may be provided to further couple together the base 180 and the grip 184. The shell 182 surrounds the base 180 and an end of the grip 184. The shell 182 is rotatable relative to the base 180 and the grip 184. To facilitate the rotation of the shell 182, the outer surfaces of the grip 184 and the shell 182 may include contours or textures (e.g., ribs, fins, angled faces, knurling, nubs, bumps, etc.) to be more easily grasped by a user. According to another exemplary embodiment, the nozzle end 119 may be coupled directly to the hose 120.

The conduit 121 is inserted into the grip 184 and is received in a socket 185 in the base 180. Fluid is directed from the conduit 121 to a nozzle tip 190 through a primary central bore 192 in the base 180. The base 180 further includes one or more secondary bores 194. The secondary bores 194 are in fluid communication with the socket 185 and are arranged in a circular arc around the central bore 192. The shell 182 includes passages 196 that can be selectively aligned with the secondary bores 194 in the base 180. Sealing elements 195 (e.g., o-rings, gaskets, a resilient coating, etc.) may be provided around the outlets of the secondary bores 194 between the base 180 and the shell 182. In a first position, the passages 196 are aligned with the corresponding bores 194 in the base, allowing fluid from the conduit 121 to be output through both the nozzle tip 190 and the passages 196 surrounding the nozzle tip 190 thereby increasing the water output cross-section of the nozzle. The user can close off the passages 196 by rotating the shell 182 relative to the base 180 and the grip 184 until the passages 196 in the shell 182 are no longer aligned with the secondary bores 194 in the base 180 thereby decreasing the water output cross-section of the nozzle. The outlets of the secondary bores 194 are sealed against an inner surface of the shell 182 by the sealing elements 195 and fluid is output only through the nozzle tip 190. An auxiliary passage 198 may be provided in one or more of the components of the spray gun 118 (e.g., the base 180, the shell 182, and/or the grip 184) that is not in fluid communication with the central bore 192, the secondary bores 194, or the passages 196. Instead, the auxiliary passage 198 may be facilitate the delivery of another substance, such as a cleaning compound that may be utilized with the fluid from the conduit 121.

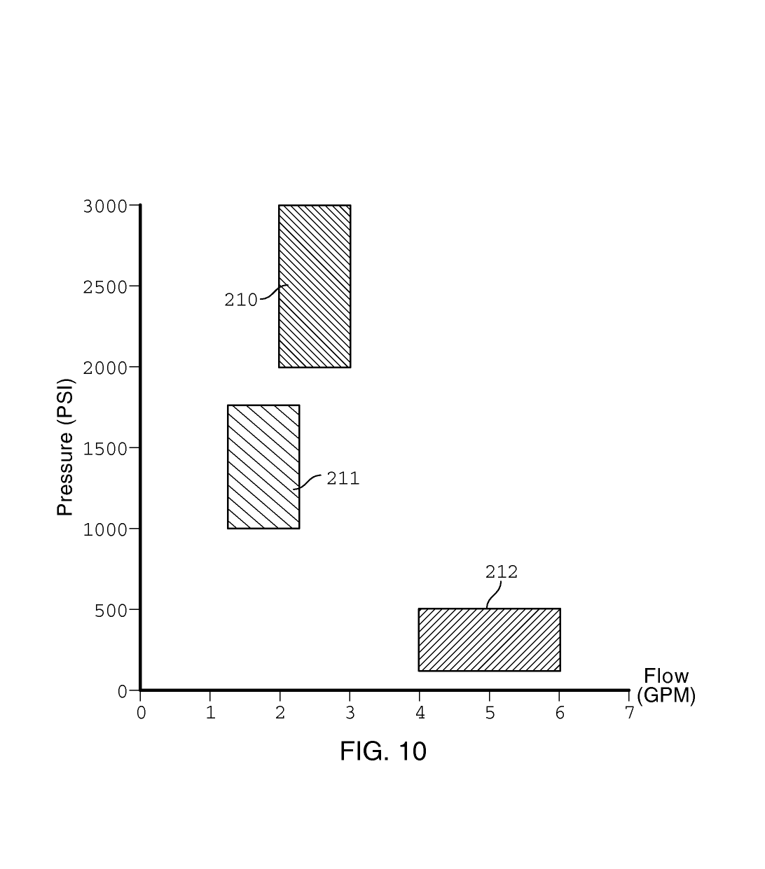

Referring to FIG. 10, the slant angles θ₁ and θ₂ of the cam 130 correspond to different modes of operation of the engine-driven water pump: a high-pressure, low-flow mode 210 and a low-pressure, high-flow mode 212. The shaded areas 210 and 212 in FIG. 10 provide exemplary zones of operation of the pump in the two modes. While the pressure and flow rate may vary in the zones, the zones do not intersect with one another, as demonstrated in FIG. 10. The angle of the cam 130 is configured to change in response to the back pressure from the nozzle of the spray gun 118. A relatively large outlet nozzle and a relatively small outlet nozzle can be provided by the spray gun 118 as described above. The large nozzle corresponds to the configuration in which fluid is output through both the central nozzle tip 190 and the outer passages 196. The small nozzle corresponds to the configuration in which the outer passages 196 are closed and fluid is output through only the central nozzle tip 190. The small nozzle creates a higher pressure stream and an increased back pressure which results in decreased displacement of the pistons 128 as the cam 130 flattens and moves toward the first slant angle θ₁ driving the pump to operate in zone 210. A minimum slant angle and flow rate are maintained by the contact of the cam 130 and the second contact surface 166. Switching to the large nozzle (e.g., by turning the shell 182) decreases the back pressure resulting in increased displacement of the pistons 128 as the cam 130 is biased toward the second slant angle θ₂ by the spring 146, driving the pump to operate in zone 212. A maximum slant angle and a minimum fluid pressure are maintained by the contact of the cam 130 and the first contact surface 164.

Use of only two modes 210, 212 with only two corresponding slant angles θ₁, θ₂ for an engine-driven water pump is intended to improve the durability and stability of the water pump 116. It is believed that less vibration and wobble of the cam 130 about the central joint 144 and correspondingly less variation in the output of the water pump 116 will occur if the pump 116 is limited to only two modes 210, 212. A reduction in the vibration and wobble of the cam 130 about the central joint 144 also reduces the repeated impact of the cam 130 against the contact surfaces 164 and 166.

In one embodiment, the water spraying device 110 may be changed from an actively spraying condition as described above to an idle or no-spray condition. When an operator releases the trigger 117 on the spray gun 118, a sensor on the gun detects that the trigger 117 is released, such as by closing or opening a circuit as a function of the position of the trigger 117. When the sensor detects that the trigger 117 has been released, the sensor communicates the information to the engine 114 (e.g., by wired or wireless communication to a receiver on the engine or in the engine control module). The release of the trigger 117 may be therefore utilized to change the speed of the engine 318, such as to an idle speed. According to another exemplary embodiment, the sensor may be a pressure sensor that is configured to sense the presence of an operator's hand on the grip 184. According to yet another exemplary embodiment, the pump includes an idle control module that places the engine into an idle speed when the trigger 117 on the spray gun 118 is released without utilizing a sensor or electronic communications.

Referring still to FIG. 10, the water pump may be operated by an electric motor in a third mode of operation 211. The pressure and flow rate of such an electric motor zone of operation 211 may intersect with the engine-driven zones 210 and 212 or may not intersect, as shown in FIG. 10.

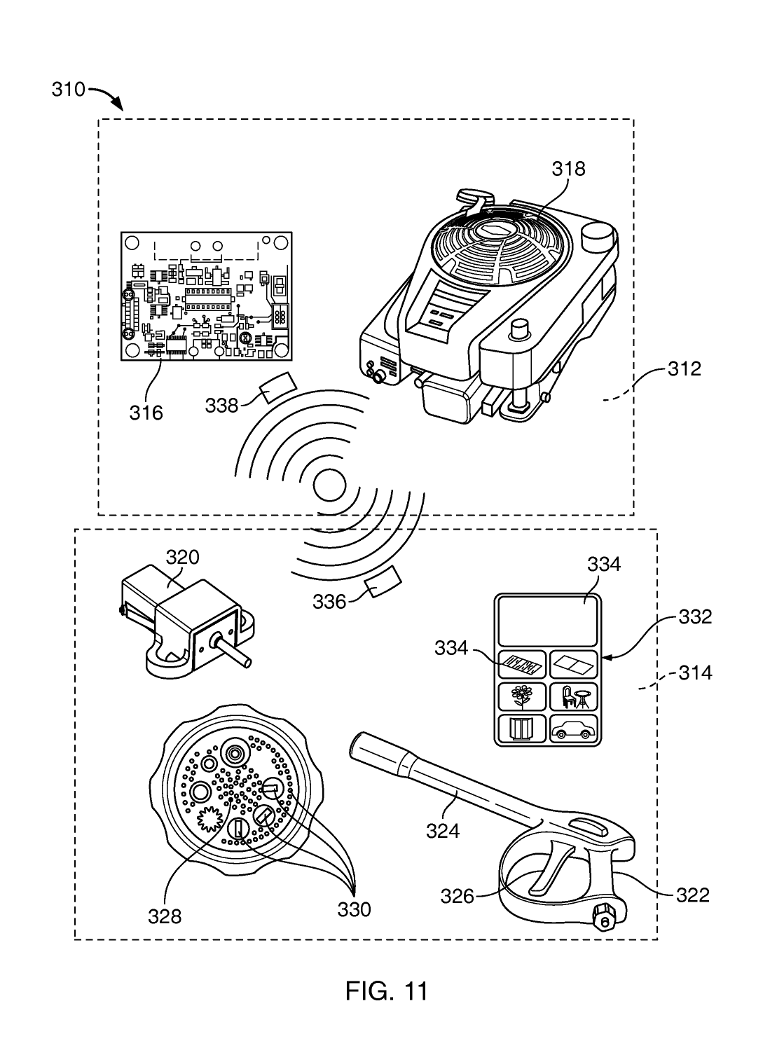

Referring to FIG. 11, according to another exemplary embodiment, a system in the form of a water spraying device 310 includes a pump assembly 312 and a spray gun 314. The pump assembly 312 includes a water pump (see, e.g., water pump 116 as shown in FIG. 1) driven by an engine 318 or another suitable prime mover such as an electric motor. The pump assembly 312 further includes circuitry 316 (e.g., electronic control unit, hardwired circuitry, computer) configured to change the speed of the engine 318. The circuitry 316 is housed in a waterproof or water-resistant compartment integrated with the water pump assembly 312. In some embodiments, the circuitry 316 is integrated with an electronic governor or throttle of the engine 318. In other embodiments, the circuitry 316 is configured to operate an actuator, such as a motor 320 (e.g., stepper motor), which adjusts a mechanical component of a governor or throttle.

According to an exemplary embodiment, water pump 116 may include a cam 130 that is pivoted relative to the holder 160 about the central joint 144 by an actuator (e.g., linear actuator, solenoid, rack and pinion, hydraulic cylinder, etc.). According to an exemplary embodiment, the actuator is coupled to (e.g., connected with, in communication with, controlled by, operated with) circuitry (see generally circuitry 316 as shown in FIG. 6), which is configured to operate the actuator to change the slant angle θ of the cam 130. The actuator may be operated, for example, by circuitry 316. The actuator is configured to change the slant angle θ of the cam 130 to either of two slant angles (see generally FIGS. 3-4), which correspond to different modes of operation of the water pump: a high-pressure, low-flow mode 210 and a low-pressure, high-flow mode 212. Use of only two modes 210, 212 with only two corresponding slant angles θ₁, θ₂ allows the actuator to be rigidly constrained in extended and retracted positions, such as by ends of a stroke for an actuator in the form of a hydraulic cylinder, which is intended to improve the durability and stability of the water pump 116. It is believed that less vibration and wobble of the cam 130 about the central joint 144 and correspondingly less variation in the output of the water pump 116 will occur if the actuator is limited to only two modes 210, 212. A reduction in the vibration and wobble of the cam 130 about the central joint 144 also reduces the repeated impact of the cam 130 against the contact surfaces 164 and 166. In other contemplated embodiments, the actuator is configured to change the slant angle θ of the cam 130 to more than two slant angles, such as three, four, or any angle within a bounded range between 0 and 90 degrees (e.g., between 5 and 45 degrees). In an exemplary embodiment, the actuator is configured to change the slant angle θ of the cam 130 to two or more slant angles within a bounded range between 0 and 17 degrees

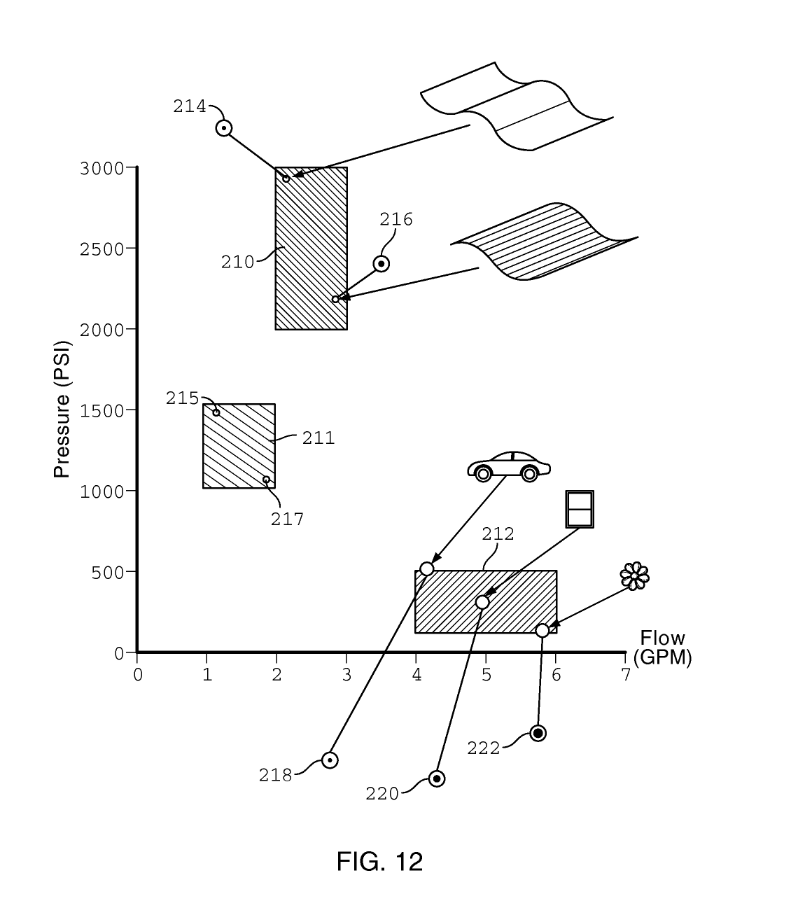

According to an exemplary embodiment, changes in characteristics of the spray may occur when the water pump 116 is in either of the two modes 210, 212 by changing the engine speed and by changing the nozzle orifice of the spray gun 118. As shown in FIG. 12, different nozzle orifices used with the different modes 210, 212 of the pump 116 may be ideal for different cleaning tasks. Operation of the spray device in the first mode 210 with a small orifice 214 may be ideal for cleaning concrete surfaces, while operation with a larger orifice 216 at a slower engine speed may be optimal for home siding. To wash a car, the water pump 116 may be operated in the second mode 212 with a relatively small orifice 218 compared to the orifice 220 used to wash windows, which may in turn be smaller than the orifice 222 used to water plants. Accordingly, in some settings the water pump 116 may be used to increase the flow rate for watering of flowers and other delicate applications. In other settings, the water pump 116 may be used to increase water pressure relative to the household water supply to strip paint, remove mold, or otherwise clean tough surfaces. As such, the water pump 116 and spray gun 118 may be used to for a broad range of outdoor applications that would otherwise require multiple water spraying devices, such as a pressure washer and a garden hose booster system.

According to the exemplary embodiment shown in FIG. 12, the two modes 210, 212 are distinct such that the flow rates and pressures of the two modes do not intersect, and a non-operation band, both with respect to flow and pressure, exists between the modes 210, 212. In this embodiment, the engine-driven water spraying device, operates at a pressure equal to or above 2000 psi (mode 210) or equal to or below 500 psi (mode 212) and at a flow rate equal to or below 3 gpm (mode 210) or equal to or above 5 gpm (mode 212). The pressure ranges and flow ranges of modes 210 and 212 may be altered in other embodiments (e.g., above 1000 psi or below 300 psi and below 2 gpm or above 1 gpm). Even though the water spraying device does not operate in certain flow and pressure bands/regions, the two modes 210, 212 of operation are suitable for many common types of cleaning, and therefore the water spraying device need not be configured to operate in the non-operation band. This configuration may permit a simplified machine design because fewer modes are required.

Referring still to FIG. 12, the water pump may be operated by an electric motor in a third mode of operation 211. The pressure and flow rate of such an electric motor zone of operation 211 may intersect with the engine-driven zones 210 and 212 or may not intersect, as shown in FIG. 10. According to an exemplary embodiment, changes in characteristics of the spray may occur when the water pump 116 is in the electric motor-driven modes 211 by changing the motor speed and by changing the nozzle orifice of the spray gun 118. As shown in FIG. 12, different nozzle orifices used with the mode 211 may be ideal for different cleaning tasks. Operation of the spray device in the mode 211 with a small orifice 215 may be ideal for cleaning concrete surfaces, while operation with a larger orifice 217 at a slower engine speed may be optimal for home siding.

According to an exemplary embodiment, the spray gun 314 includes a handle 322, a barrel 324 (e.g., shaft), and a trigger 326. In some embodiments, the spray gun 314 includes a head 328 on a distal end of the barrel 324. The head 328 may include a variable outlet to change the structure through which the water flows when spraying from the spray gun 314. In some embodiments, the head 328 includes a variety of nozzle orifices 330 that may be rotated into and out of an active position that is aligned with a flow path through the head 328. Some of the orifices 330 may have larger openings (i.e., a larger water output cross-section) than others. Some of the orifice 330 may have circular openings, while others have flat slots or are otherwise shaped. Some of the orifices 330 may include an array of small openings (e.g., patterned pin holes).

According to an exemplary embodiment, the spray gun 314 includes an interface 332 configured to receive input from an operator of the spray gun 314, and communicate the input to the water pump assembly 312 for control of the water pump. The interface 332 may include buttons, a dial, levers, a touch screen, or other features that allow the operator to provide input. In some embodiments, the interface 332 further includes an electronic display 334 (e.g., computerized display, screen). The electronic display 334 may include information associated with the water of the spray gun 314, such as the flow rate, the water pressure, the nozzle orifice shape, the cumulative amount of water used, the duration of spraying, etc.

In some embodiments, the spray gun 314 further includes a motor (see generally motor 320) or other actuator that rotates the head 328 of the spray gun 314 to change which particular nozzle orifice 330 is active. The motor 320 may be a throttle stepper motor. The operator may select a setting of the water spraying device 310 via the interface 332 of the spray gun 314, and circuitry (see generally circuitry 316) may direct the motor to rotate the head 328 accordingly. In some embodiments, the interface 332 of the spray gun 314 is integrated with the barrel 324 or the handle 322. In other contemplated embodiments, the interface 332 of the spray gun 314 is integrated with the head 328, where rotation of the head 328 is sensed and a corresponding signal is communicated to the water pump assembly 312 to change the mode of operation of the water pump as a function of rotating the head 328 or the particular nozzle orifice 330 positioned in the active position.

Inputs provided by the operator of the hand gun 314 may be communicated to the circuitry 316 of the water pump assembly 312, to change operation of the pump (see, e.g., pump 116 as shown in FIG. 1) and engine 318. In some embodiments, input is communicated to the water pump assembly 312 via a wired connection, such as a wire coupled to a hose (see, e.g., hose 120 as shown in FIG. 1) connected between the spray gun 314 and the water pump assembly 312. In other embodiments, the input is communicated wirelessly to the water pump assembly 312, where the spray gun 314 includes a transmitter 336 (e.g., transceiver, radio-frequency source) and the water pump assembly 318 includes a receiver 338 (e.g., transceiver, radio-frequency sensor). According to other embodiments, the communication between the spray gun 314 and the water pump assembly 318 may be two-way communication.

In some embodiments, communications from the spray gun 314 are received by the circuitry 316 of the pump assembly 312, which then changes the mode 210, 212 of the water pump by changing the slant angle θ of the cam with the actuator (see FIG. 2). In some embodiments, communications from the spray gun 314 are received by the circuitry 316 of the pump assembly 312, which then changes the speed of the engine 318 by changing the throttle setting with the motor 320. In other embodiments, communications from the spray gun 314 change the engine speed by changing the target speed or target range of the electronic governor, without the motor 320. In other embodiments, the pump assembly may not be a variable pump assembly. Instead, the mode 210, 212 of the water spraying device 310 may be accomplished with only adjustments to the nozzle orifice 330 and the speed of the engine 318 (e.g., via electronic communication between the nozzle and the engine).

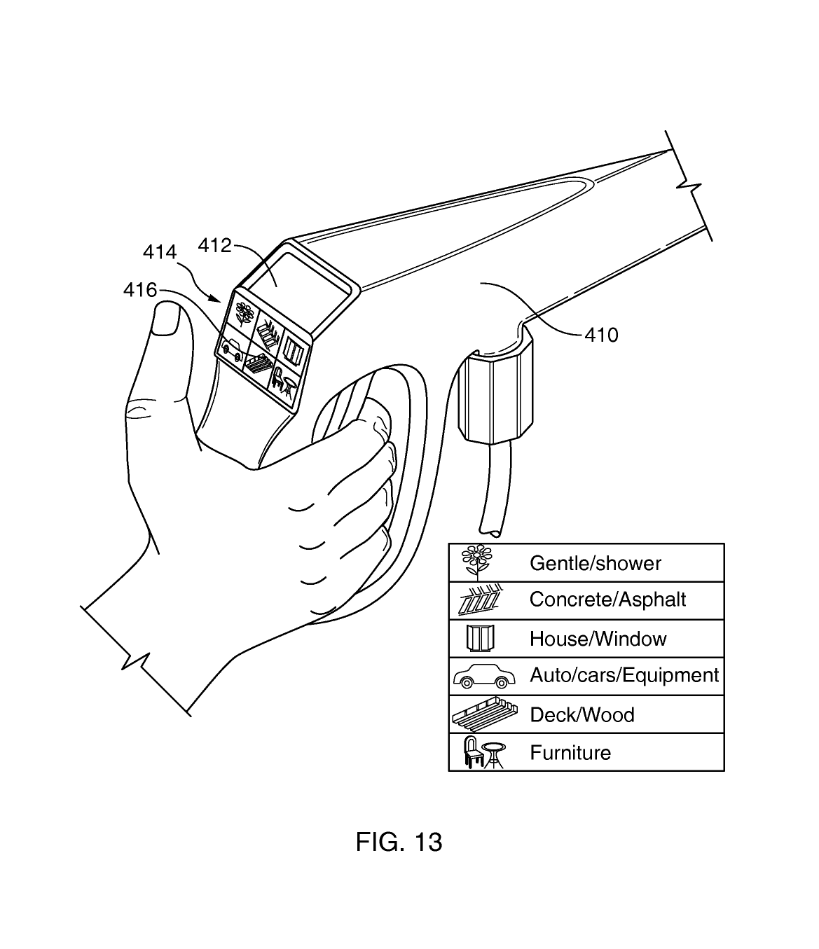

Referring to FIG. 13, in some embodiments, a spray gun 410 includes an electronic display 412 and a touch screen 414. The electronic display 412 and touch screen 414 are coupled to circuitry integrated with the spray gun 410 (see generally circuitry 316 as shown in FIG. 6) configured to provide an array of icons 416 on the display 412, such as icons corresponding to different settings of the water spraying device.

In some embodiments, each of the icons 416 corresponds to a unique flow condition provided by the water spraying device. The unique flow condition may differ from flow conditions associated with other icons 416 with regard to one or more attributes of the flow provided by the spray gun 410, such as water pressure, flow velocity, spray shape due to nozzle orifice geometry, flow rate, flow dithering (i.e., oscillating in pressure, velocity, flow rate, direction), inclusion of chemicals (e.g., detergent), turbulence (e.g., laminar versus turbulent flow), and other attributes.

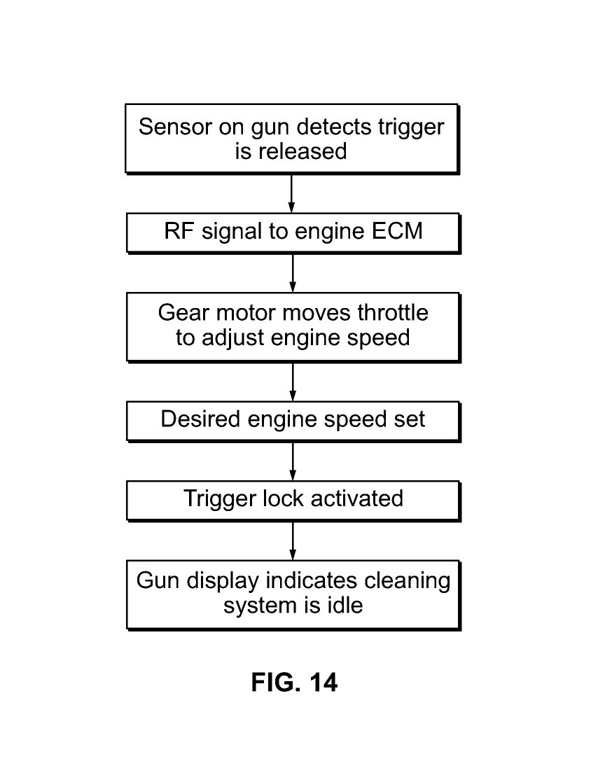

Referring to FIGS. 11 and 14, a method for operating a water spraying device includes changing the setting of the water spraying device 310 (FIG. 11) from actively spraying to an idle or no-spray condition. When an operator releases the trigger 326 on the spray gun 314, a sensor on the gun detects that the trigger 316 is released, such as by closing or opening a circuit as a function of the position of the trigger 326. When the sensor detects that the trigger 326 has been released, the sensor communicates the information to the circuitry of the spray gun 314, which provides associated information to the transmitter 336. A radio-frequency signal is provided by the transmitter 336 on the spray gun 314 to the circuitry 316 coupled to the engine 318 by way of the receiver 338. The motor 320 moves the throttle of the engine 318 to change the speed of the engine 318, such as to an idle speed. Concurrently, a trigger lock (e.g., solenoid driven pin or latch coupled to the control circuitry) in the spray gun 314 interlocks the trigger 326. The electronic display 334 then indicates that the water spraying device 310 is idle or inactive.

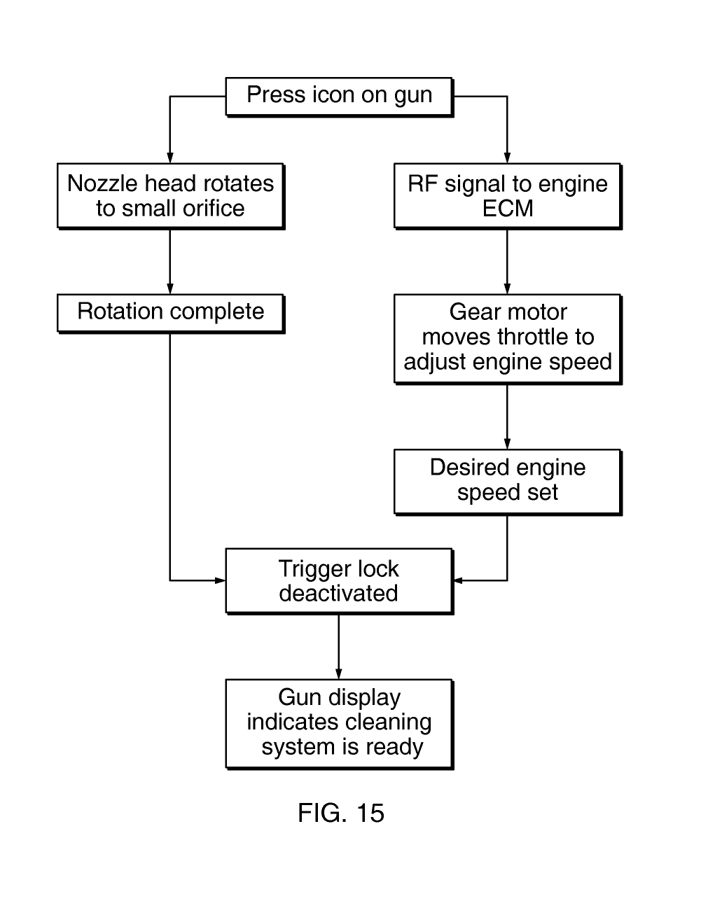

Referring to FIGS. 11-13 and 15, a method of operating the water spraying device 310 includes changing the setting of the water spraying device 310 from actively spraying in a first setting to actively spraying in a second setting, or from being idle to actively spraying. Of the variety of different icons 416 (see FIG. 13), the operator selects an icon 416 on the touch screen 414 of the spray gun 410 corresponding to a particular setting. Upon selecting of the icon 416, a motor (see generally motor 320 as shown in FIG. 11) integrated with the spray gun 314 (FIG. 11) rotates the head 328 of the spray gun 314 to a corresponding nozzle orifice 330. Concurrently, the spray gun 314 communicates a wireless signal to the circuitry 316 of the water pump assembly 312 (e.g., electronic engine control module). The motor 320 that is coupled to the throttle of the engine 318 changes the engine speed, or the electronic control module changes the target speed of the governor. When the desired speed of the engine 318 is achieved and the head 328 of the spray gun 314 is rotated to the appropriate nozzle orifice 330, the lock on the trigger 326 is released and the electronic display 334 indicates that the spray gun 314 is ready for operation.

Referring once more to FIGS. 1-2, in some contemplated embodiments, a pressure sensor 150 (FIG. 2) is connected to the water pump 116 and provides (wired, wireless, mechanical (e.g., Bowden cable 152 in FIG. 1)) feedback to the electronic control module or throttle of the engine 114. When the water pump 116 is in recirculation, such as when the throttle is released and trapped pressure opens an unloader valve (not shown) of the water pump 116, then the pressure sensor 150 communicates instructions to idle the engine 114. When the trigger is pulled, water sprays from the spray gun 118, the unloader valve closes and the resulting change in pressure is sensed and communicated by the pressure sensor 150 to the engine 114, to return the engine 114 to operational speed.

In contemplated embodiments, the circuitry 316 water spraying device 310 is configured to interface with outside computers, such as via a wired or wireless connection. The operator may download new icons and flow settings for the water spraying device 310. An online database may include a large library of different icons and associated spraying options that are particularly tailored to nuanced applications, such as cleaning clay from the treads of a particular type of tire or watering a particular type of rose bush. In some embodiments, an operator or other person may develop their own customized settings for the water spraying device 310 that may be communicated directly to the water spraying device 310 and added to the online database. In contemplated embodiments, a water spraying device 310 (e.g., spray gun or water pump assembly) may include a seat or compartment to support a smart phone or other portable computer that includes various spray settings and control options.

The construction and arrangements of the water spraying device, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. Other substitutions, modifications, changes and omissions may also be made in the design, operating conditions and arrangement of the various exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A water spraying system configured for a variety of different outdoor cleaning applications, comprising:
a water pump configured to operate in only two modes:
a first mode corresponding to a first range of water pressure and a first range of water flow rate; and
a second mode corresponding to a second range of water pressure and a second range of water flow rate,
wherein the first range of water pressure does not overlap the second range of water pressure, and wherein the first range of water flow rate does not overlap the second range of water flow rate; and
a spray gun coupled to the water pump and comprising an interface configured to allow an operator to change the mode of operation of the water pump.

2. The system of claim 1, wherein the interface of the spray gun comprises an electronic display and a touch screen coupled to circuitry;
wherein the circuitry is configured to present an array of icons to an operator via the electronic display, wherein the icons are selectable by the operator via the touch screen;
wherein upon selection of a first icon of the array of icons, the circuitry instructs the water pump to operate in the first mode; and
wherein upon selection of a second icon of the array of icons, the circuitry instructs the water pump to operate in the second mode.

3. The system of claim 2, wherein the spray gun further comprises a transmitter and the water pump is coupled to a receiver, and wherein instructions provided by the operator via the interface to change the mode of the water pump are transmitted wirelessly from the transmitter to the receiver.

4. The system of claim 1, wherein the first mode corresponds to a range of water pressure of at least approximately 2000 psi and a range of water flow rate between approximately 2 and 3 gpm and the second mode corresponds to a range of water pressure between approximately 100 and 500 psi and a range of water flow rate between approximately 5 and 6 gpm

5. The system of claim 1, wherein the interface comprises one of a switch, a lever, or a button.

6. A water spraying system configured for a variety of outdoor cleaning applications, comprising:
a water pump assembly, comprising:
a water pump;
a receiver configured to receive wireless communications; and
an actuator coupled to the receiver and configured to change at least one of water pressure and flow rate provided by the water pump; and
a spray gun configured to spray water provided by the water pump, comprising:
an electronic display;
circuitry configured to provide a graphical user interface via the electronic display; and
a transmitter configured to electrically provide instructions to the actuator by way of the receiver based on input provided by the operator, such that the operator may change at least one of the water pressure and the flow rate provided by the water pump via the graphical user interface of the spray gun.

7. The system of claim 6, wherein the electronic display comprises a touch screen configured to receive the input provided by the operator.

8. The system of claim 7, wherein the graphical user interface comprises an array of icons corresponding to different settings of the water spraying system.

9. The system of claim 8, wherein the spray gun comprises:
a head having a variety of nozzle outlets and configured to be rotated such that individual nozzle outlets of the variety of nozzle outlets may be rotated into and out of an active position for conditioning water flowing through the individual nozzle outlets; and
a motor configured to rotate the head,
wherein upon selection of a first icon of the array of icons, the circuitry provides instructions to the motor that include rotating the head to a first nozzle outlet of the variety of nozzle outlets, and
wherein upon selection of a second icon of the array of icons, the circuitry provides instructions to the motor that include rotating the head to a second nozzle outlet of the variety of nozzle outlets.

10. The system of claim 8, wherein the water pump assembly further comprises an engine having a throttle, wherein the engine drives the water pump,
wherein upon selection of a first icon of the array of icons, the circuitry provides instructions to the throttle that include operating the engine at a first speed, and
wherein upon selection of a second icon of the array of icons, the circuitry provides instructions to the throttle that include operating the engine at a second speed.

11. The system of claim 10, wherein the throttle is coupled to the receiver, and wherein the circuitry provides the instructions via the transmitter that are communicated to the throttle via the receiver.

12. The system of claim 8, wherein the water pump assembly further comprises an electric motor having a speed control, wherein the electric motor drives the water pump,
wherein upon selection of a first icon of the array of icons, the circuitry provides instructions to the speed control that include operating the electric motor at a first speed, and
wherein upon selection of a second icon of the array of icons, the circuitry provides instructions to the speed control that include operating the electric motor at a second speed.

13. The system of claim 12, wherein the speed controller is coupled to the receiver, and wherein the circuitry provides the instructions via the transmitter that are communicated to the speed controller via the receiver.

14. The system of claim 8, wherein the water pump is configured to operate in two modes:
a first mode corresponding to a first range of water pressure and a first range of water flow rate; and
a second mode corresponding to a second range of water pressure and a second range of water flow rate,
wherein the first range of water pressure does not overlap the second range of water pressure, and wherein the first range of water flow rate does not overlap the second range of water flow rate.

15. The system of claim 14, wherein upon selection of a first icon of the array of icons, the circuitry provides instructions to the actuator that include operating the water pump in the first mode; and wherein upon selection of a second icon of the array of icons, the circuitry provides instructions to the actuator that include operating the water pump in the second mode.

16. The system of claim 8, wherein different icons of the array of icons correspond to different combinations of flow rate, water pressure, and nozzle outlet settings.

17. The system of claim 6, wherein the spray gun comprises a handle, a trigger, and a barrel, wherein a top of the handle connects to a rear of the barrel, and wherein the electronic display is positioned proximate to the top of the handle and the rear of the barrel.

18. The system of claim 17, wherein the electronic display is positioned opposite to the trigger about the barrel and the handle.

19. The system of claim 6, further comprising:
an engine for driving the water pump and comprising a throttle to control the speed of the engine;
a pressure sensor coupled to the water pump; and
a linkage coupling the throttle and the pressure sensor such that the engine speed is at least partially controlled by the pressure of water in the water pump.

20. The system of claim 6, further comprising:
an electric motor for driving the water pump and comprising a speed controller to control the speed of the electric motor;
a pressure sensor coupled to the water pump; and
a linkage coupling the speed controller and the pressure sensor such that the electric motor speed is at least partially controlled by the pressure of water in the water pump.

21. A water spraying system, comprising:
a water pump comprising:
a piston for pumping water;
a cam that rotates and comprises a face contacting the piston, wherein the face is oriented at a slant angle relative to a plane orthogonal to the axis of rotation of the cam such that rotation of the cam drives the piston; and
an actuator configured to change the slant angle of the cam, wherein the actuator is configured to move the cam between first and second slant angles such that the cam drives the piston to a lesser stroke length when the cam is oriented at the first slant angle compared to when the cam is oriented at the second slant angle; and
a spray gun in communication with the actuator, wherein the spray gun comprises an interface configured to allow an operator to change the slant angle of the cam via the actuator.

22. The system of claim 21, wherein the water pump comprises constraints configured to hold the cam at the first and second slant angles, but not at intermediate angles.

23. The system of claim 21, wherein the spray gun comprises a transmitter and the water pump comprises a receiver, and wherein the transmitter is configured to wirelessly provide instructions from the operator via the interface to the actuator by way of the receiver.

24. The system of claim 21, wherein the interface of the spray gun comprises an electronic display and a touch screen coupled to circuitry;
wherein the circuitry is configured to present an array of icons to an operator via the electronic display, which are selectable by the operator via the touch screen;
wherein upon selection of a first icon of the array of icons, the circuitry instructs the actuator to operate the cam at the first slant angle; and
wherein upon selection of a second icon of the array of icons, the circuitry instructs the actuator to operate the cam at the second slant angle.

25. A water spraying system, comprising:
a prime mover having a variable prime mover speed;
a water pump driven by the engine at a pump speed that is related to the prime mover speed;
a hose coupled to an outlet of the water pump;
a nozzle coupled to the hose and configured to spray water delivered by the pump, the nozzle comprising:
a first setting having a first output cross-section;
a second setting having a second output cross-section, wherein the second output cross-section is less than the first output cross-section;
wherein the prime mover speed and the pump speed are higher when the nozzle is in the first setting than when the nozzle is in the second setting.

26. The system of claim 25, wherein the nozzle is configured to communicate electronically with the prime mover to decrease the prime mover speed when the nozzle is changed from the first setting to the second setting.

27. The system of claim 25, wherein the pump is a positive displacement pump having an output water flow rate that is solely a function of pump speed.

28. The system of claim 25, wherein the pump is a variable displacement pump having an output water flow rate that can be changed without changing the pump speed.

29. The system of claim 25, wherein the prime mover is one of an internal combustion engine or an electric motor.
